(19) United States
(12) Patent Application Publication
(10) Pub. No.: US 2021/0055875 A1
(43) Pub. Date: Feb. 25, 2021

(54) ELASTIC, MULTI-TENANT, AND EXCLUSIVE STORAGE SERVICE SYSTEM

(71) Applicant: Hitachi, Ltd., Tokyo (JP)

(72) Inventor: Masanori TAKADA, Santa Clara, CA (US)

(73) Assignee: Hitachi, Ltd.

(21) Appl. No.: 16/547,303

(22) Filed: Aug. 21, 2019

(51) Int. Cl. G06F 3/06; H04L 12/911; H04L 29/08

(52) U.S. Cl. CPC G06F 3/0644; G06F 3/0614; H04L 67/1097; G06F 3/0659; H04L 47/70; G06F 3/067

(57) ABSTRACT

Example implementations described herein are directed to a storage service system providing elastic, exclusive storage service to multiple users. In the example implementations, there is a storage system service involving a plurality of storage clusters configured to be isolated from each other, each of the plurality of storage clusters configured to be directed to a public cloud, and managed by a management server. Such a storage service system can also involve storage nodes that are in a colocation data center.

### BACKGROUND

### Field

The present disclosure is directed to cloud system management, and more specifically, to management of storage clusters for tenants.

### Related Art

Public cloud has become implemented more widely in the related art, and can involve implementations such as building new services on a cloud platform, migrating some systems from an on-premise storage, or building hybrid systems of on-premise storage and public cloud for facilitating both implementations.

One aspect of public cloud is that users can easily expand the underlying Information Technology (IT) resources simply from sending some commands, without additional hardware installation. Such related art implementations reduce the time for preparing resources and facilitates more flexibility regarding the amount of resources (e.g., such as expanding the resources to become 100 times larger).

On the other hand, some users may want to store their data outside the public cloud. For example, some users may want to keep data compliance policies not achieved by storing the data in public cloud, and other users may want to make the data store compatible with their on-premise data center for application compatibility, or some features synchronizing the data between on-premise and public cloud. For such use cases, it is often used by installing data storage in the collocation data-center and connecting the data storage and public cloud with some low latency network services, for using the data in public cloud. This is known as “colocation storage”.

In colocation storage implementations, users may want to use the storage as exclusive resources for each user. Some users may want the resources separated from other users for compliance with data laws or other requirements, and others may want compatibility with the on-premise exclusive storage. One related art implementation to facilitate such requirements involves installing multiple data storages exclusively for each user. However, the users may want to use the data storage as a cloud-like resource and such an approach requires sizing, installation, and others prior to use the data storage.

In a related art implementation, a multi-tenant cloud storage is disclosed. Such related art implementations involve utilizing web interfaces providing storage resources to multiple tenants. Another related art implementation involves a share storage and security authorization features for multiple client systems.

### SUMMARY

Related art implementations fail to provide elastic and scalable storage resources to multiple users. To address the problems above, example implementations can involve a management server configured to manage a plurality of storage clusters, each of the plurality of storage clusters associated with a user, each of the plurality of storage clusters configured to be isolated from each other, each of the plurality of storage clusters configured to be directed to a public cloud, the management server involving a processor, configured to, responsive to a request to expand a first storage cluster from the plurality of storage clusters, provide an instruction to a virtual infrastructure manager to add an unused storage node to the first storage cluster and directed to the first storage cluster; expand storage software service of the first storage cluster to the added unused storage node, and execute, on the first storage cluster, the storage software service to direct the added unused storage node to the first storage cluster.

Aspects of the present disclosure can further involve a method for a system involving a plurality of storage clusters, each of the plurality of storage clusters associated with a user, each of the plurality of storage clusters configured to be isolated from each other, each of the plurality of storage clusters configured to be directed to a public cloud, the method including responsive to a request to expand a first storage cluster from the plurality of storage clusters, providing an instruction to a virtual infrastructure manager to add an unused storage node to the first storage cluster and directed to the first storage cluster; expanding storage software service of the first storage cluster to the added unused storage node, and executing, on the first storage cluster, the storage software service to direct the added unused storage node to the first storage cluster.

Aspects of the present disclosure can include a system, involving a plurality of storage nodes configured to provide storage; a plurality of storage clusters, each of the plurality of storage clusters associated with a user, each of the plurality of storage clusters configured to be isolated from each other, each of the plurality of storage clusters configured to be directed to a public cloud, each of the plurality of storage clusters facilitated by one or more of the plurality of storage nodes; and a management server, involving a processor, configured to, responsive to a request to expand a first storage cluster from the plurality of storage clusters: provide an instruction to a virtual infrastructure manager to add an unused storage node from the plurality of storage nodes to the first storage cluster of the plurality of storage clusters and directed to the first storage cluster; expand storage software service of the first storage cluster of the plurality of storage clusters to the added unused storage node, and execute, on the first storage cluster of the plurality of storage clusters, the storage software service to direct the added unused storage node to the first storage cluster.

Aspects of the present disclosure can further involve a system involving a plurality of storage clusters, each of the plurality of storage clusters associated with a user, each of the plurality of storage clusters configured to be isolated from each other, each of the plurality of storage clusters configured to be directed to a public cloud, the system including responsive to a request to expand a first storage cluster from the plurality of storage clusters, means for providing an instruction to a virtual infrastructure manager to add an unused storage node to the first storage cluster and directed to the first storage cluster; means for expanding storage software service of the first storage cluster to the added unused storage node, and means for executing, on the first storage cluster, the storage software service to direct the added unused storage node to the first storage cluster.

In accordance with the example implementations as noted above, the storage clusters can be managed as an exclusive storage resource and collocated within the same physical data center location, while still having the storage nodes facilitate tenants for public cloud in the same location. Further, the storage clusters can be isolated from each other to facilitate implementations for multiple users, such that multiple users can have public cloud and on-premise storage. In addition, through the example implementations described herein, nodes can be added or removed from storage clusters by the user.

### BRIEF DESCRIPTION OF DRAWINGS

FIG. 1 illustrates an elastic multitenant storage service system, application using the system, and users who uses and manages the system and applications, in accordance with an example implementation.

FIG. 2 illustrates an example of a tenant management table stored in the resource management service function, in accordance with an example implementation.

FIG. 3 illustrates an example of a process for adding nodes by the resource management service function, in accordance with an example implementation.

FIG. 4 illustrates an example of a process of removing nodes by the resource management service function, in accordance with an example implementation.

FIG. 5 illustrates an example of a process of the manage service for adding nodes to the storage cluster, in accordance with an example implementation.

FIG. 6 illustrates an example of a process of the manage service for removing nodes from the storage cluster, in accordance with an example implementation.

FIG. 7 illustrates a physical configuration for a system upon which example implementations may be applied.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations. Through the present disclosure, the term “tenant” and “user” may also be used interchangeably.

Example implementations described herein are directed to storage service system providing exclusive use as if the user owns a storage cluster, while providing elasticity for expanding/contracting the amount of resources.

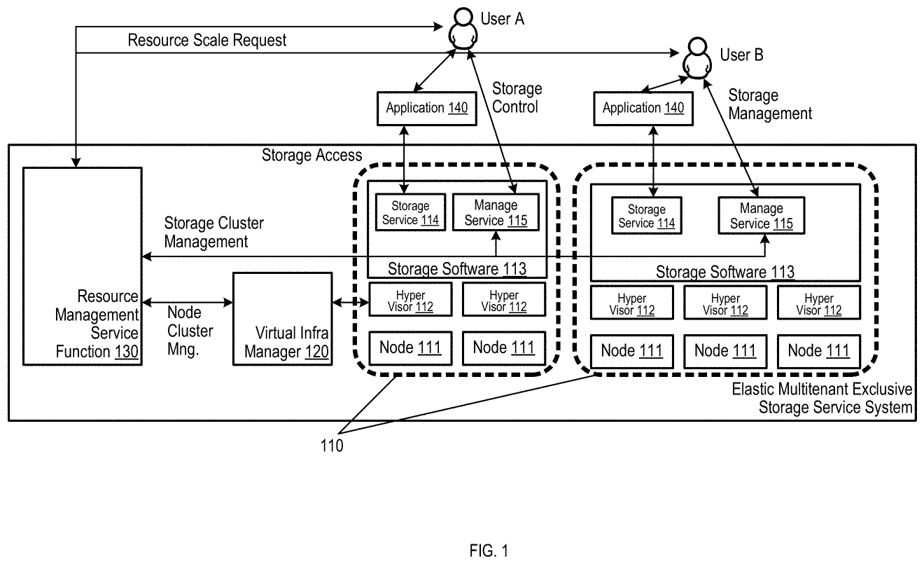

FIG. 1 illustrates an elastic multitenant storage service system, application using the system, and users who uses and manages the system and applications, in accordance with an example implementation. The example implementation of FIG. 1 provides virtual storage systems for multiple tenants by managing storage clusters 110. The system can involve multiple nodes 111, hypervisors 112 running on the nodes 111, storage software 113 running on the multiple nodes 111 via hypervisors 112, and a virtual infrastructure manager 120, and a resource management service function 130.

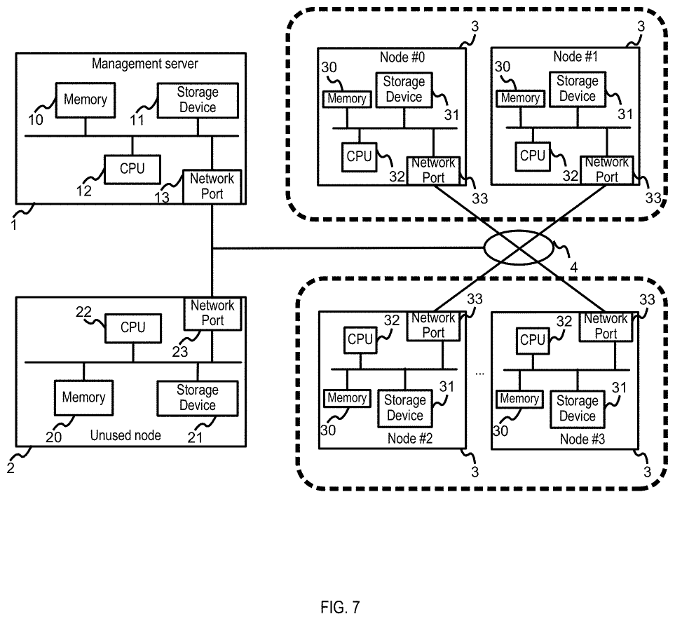

The nodes 111 can involve server hardware such as microprocessors, memory, and some drives such as HDDs and/or SSDs. Further details of the hardware configuration of the nodes 111 are provided with respect to FIG. 7. Hypervisor 112 virtualizes the nodes 111 and provides a virtualized infrastructure involving computing, memory, storage and network resources. Storage software 113 is a software application running on the nodes 111 configured to provide storage services such as storing data or protecting data by using redundancy techniques like duplication or erasure coding. Storage software 113 also provides local replication functionality such as snapshot, remote replication, and data deduction like deduplication/compression.

These services are provided by storage service 114. Depending on the desired implementation, storage software 113 can also provide manage service 115 functionality which provides service configurations.

The virtual infrastructure manager 120 manages multiple nodes 111 and hypervisors 112. The virtual infrastructure manager 120 can provide support for adding/removing nodes to one of the virtual infrastructures, based on the request of the resource management service function 130.

The resource management service function 130 manages the virtual infrastructure manager 120 and manages services in the storage software 113 to expand or contract the clusters of storage software 113 based on the request from the user of each tenant.

The users run applications 140 using the storage service 114, and controls storage services 114 via the manage service 115. The users also control the amount of storage services 114 by communicating with the resource management service function 130. Depending on the desired implementation, the applications 140 are accessed through a public cloud. For example, in example implementations in which the applications 140 are implemented on a public cloud, the storage clusters 110 are configured to respond to a request for a read operation or a write operation as received from the application 140 through storage service 114. For example, in an example involving a read operation, the application 140 provides a read request to the storage service 114 of the corresponding storage cluster 110, whereupon the storage service 114 responds to the request with the corresponding data for the read request. In another example involving a write operation, the application 140 provides a write request to the storage service 114 of the corresponding storage cluster 110 along with the data used for the write request, whereupon the storage service 114 executes a process to facilitate the writing of the data into the nodes 111 of the storage cluster 110 as appropriate and provides a response to the write request to the application 140 (e.g., responding with acknowledgement, progress, completion, etc.)

The system of FIG. 1 facilitates an elastic multitenant exclusive storage system, which is facilitated by the hardware environment as illustrated in FIG. 7. Example implementations provide a storage cluster for a user and storage service 114 and manage service 115 to provide a private storage system which enables user to use like an on-premise storage system. The user can add or remove storage nodes as required. For example, if the user desires to pay extra to a cloud service and request for additional storage, the user can thereby have a storage node allocated to the corresponding storage cluster. Users may conduct expansion or contraction to ensure performance or ensure full capacity for each tenant.

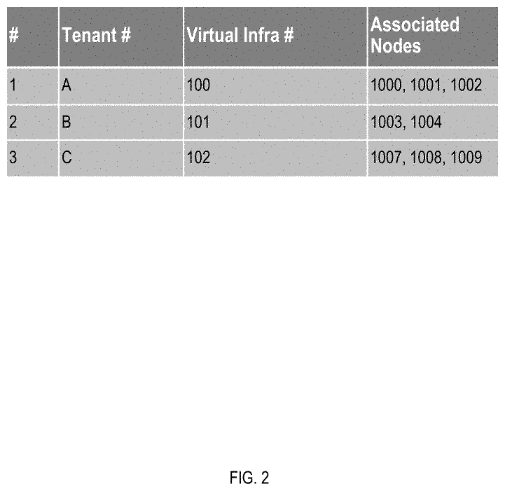

FIG. 2 illustrates an example of a tenant management table stored in the resource management service function 130, in accordance with an example implementation. Specifically, the tenant management table manages the tenant identifier (ID), virtual infrastructure ID and associated nodes managed by the virtual infrastructure manager 120. In this example, tenant A corresponds to virtual infrastructure #100 and it has three nodes named #1000, #1001, #1002.

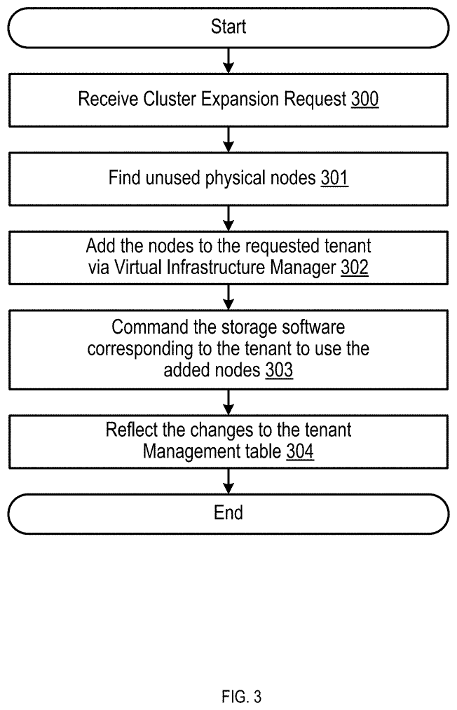

FIG. 3 illustrates an example of a process for adding nodes by the resource management service function, in accordance with an example implementation. The resource management service function 130 invokes this process when a user wants to expand their storage resource. At 300, the resource management service function 130 receives a cluster expansion request from tenant, and then finds unused physical nodes in the system at 301. At 302, the resource management service function 130 requests to the virtual infrastructure manager 120 to add the unused nodes to the requested tenant. At 303, the resource management service function 130 also requests the storage software 113 of the corresponding storage cluster 110 to use the added nodes. Then, at 304 the resource management service function 130 modifies the tenant management table to reflect the changes involving the node added to a tenant.

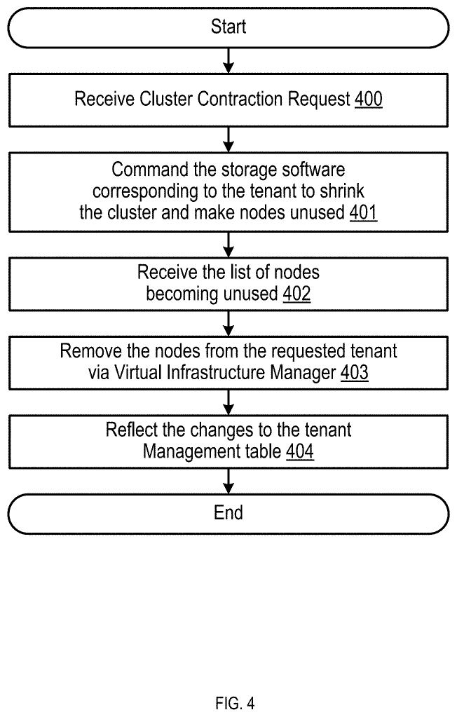

FIG. 4 illustrates an example of a process of removing nodes by the resource management service function, in accordance with an example implementation. The resource management service function 130 invokes this process when a user wants to contract (e.g., reduce) their storage resources. At 400, the resource management service function 130 receives a cluster contraction request from tenants, then requests the storage software 113 to shrink the storage cluster and make some of the nodes unused at 401. At 402, the resource management service function 130 waits for the response from the storage software regarding which nodes became unused. After receiving the list of unused nodes, at 403 the resource management service function 130 removes the nodes from the request tenant, by requesting to the virtual infrastructure manager 120 to remove the nodes from the corresponding virtual infrastructure. Then at 404, the resource management service function 130 modified the tenant management table the changes the nodes removed from the tenant.

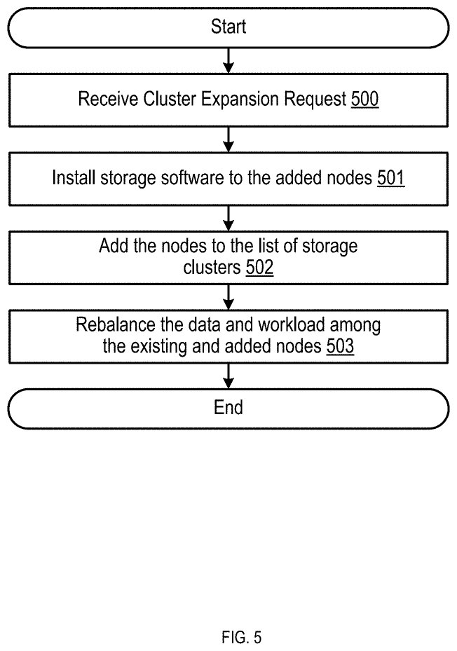

FIG. 5 illustrates an example of a process of the manage service for adding nodes to the storage cluster, in accordance with an example implementation. The manage service 115 invokes this process when requested to do so by resource management service function 130. At 500, the manage service 115 receives a cluster expansion request, with information about added nodes, resource management service function 130. At 501, the manage service 115 installs storage software to the nodes. At 502, the manage service 115 then adds the nodes to the list of storage clusters managed by the manage service 115 itself. Then, at 503, the manage service 115 rebalances the data and workload among the existing and added nodes.

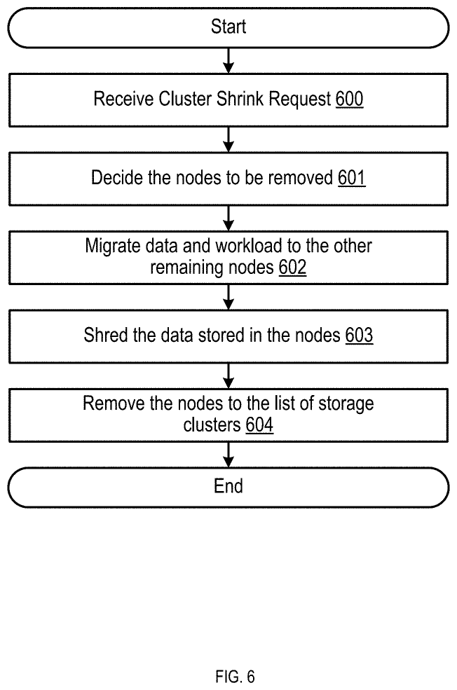

FIG. 6 illustrates an example of a process of the manage service for removing nodes from the storage cluster, in accordance with an example implementation. The manage service 115 invokes this process when requested to do so by resource management service function 130. At 600, the manage service 115 receives a cluster contraction request from the resource management service function 130. At 601, the manage service 115 determines which nodes are to be removed. Then at 602, the manage service 115 migrates data and workload from the nodes to the other remaining nodes. At 603, the manage service 115 erases the data stored in the to-be-removed nodes, and then at 604 the manage service 115 removes the nodes from the list of storage clusters.

Through example implementations described herein, multiple storage clusters providing multiple virtual storage systems for multiple tenants can be realized from a single node cluster. The virtualization mechanism is realized by hypervisor and virtual infrastructure management, so the user can use the storage system as if it is a physical storage system. Further, the storage cluster can be expanded/contracted by the resource management function so that the users do not have to prepare the hardware for their own use. Hence, the example implementations provide elastic storage service exclusively to multiple users.

The example implementations can be used for a colocation storage service, from which users may need elasticity because of the combination with a public cloud, separation from public cloud, or from other users.

FIG. 7 illustrates a physical configuration for a system upon which example implementations may be applied. In the example of FIG. 7, management server 1, unused nodes 2 and nodes 3 utilized in one or more storage clusters are connected to each other via network 4. The management server 1 can include memory 10, storage devices 11, central processing unit (CPU) 12, and network port 13. Unused nodes 2 can include memory 20, storage devices 21, CPU 22, and network port 23. Nodes 3 utilized in one or more storage clusters can include memory 30, storage devices 31, CPU 32 and network port 33. CPUs 12, 22 and 32 can be in the form of a physical hardware processor, or a combination of hardware and software processors to facilitate the desired implementation.

Memory 10, 20 and 30 can take the form of any memory depending on the desired implementation, such as dynamic random access memory (DRAM). Network 4 can be implemented as any type of network in accordance with a desired implementation, such as an internet protocol (IP) Network or a Storage Area Network (SAN).

Storage Devices 21 from the unused nodes 2 as well as storage device 31 in nodes 3 can involve flash devices or disks such as hard disk drives (HDD). The latency for access to flash devices is shorter than the latency for access to disk.

In an example of an input/output (I/O) process for FIG. 7, management server 1 can execute the functionality of the resource management service function 130 and the virtual infrastructure manager 120. To facilitate the functions and the flow as illustrated in FIGS. 3-6, CPU 12 is configured to execute the functions of the resource management service function 130 to manage the virtual infrastructure manager 120, which is another program that communicates to the storage nodes 3 and unused nodes 2 through hypervisor 112. Management server 1 may receive such instructions from users through manage service 115.

As shown in the system of FIG. 7 the system can involve a plurality of storage nodes 3 configured to provide storage for a plurality of storage clusters. Each of the plurality of storage clusters is associated with a user and configured to be isolated from each other. In the example of FIG. 7, there is one storage cluster involving storage nodes #0 and #1, and another storage cluster involving storage nodes #2 and #3, the storage nodes thereby facilitating storage for the storage clusters in accordance with the desired implementation. Unused nodes 2 may also facilitate the provision of additional storage for storage clusters and can be added to storage clusters, when allocated by virtual infrastructure manager 120 as instructed by resource management service function 130. In example implementations, storage software 113 can be implemented by CPU 32 to facilitate the functionality of storage service 114 and manage service 115. When the storage node 3 is utilized in a storage cluster, users can send instructions to manage service 115 and storage service 114 as facilitated by CPU 32. CPU 32 may also facilitate the functionality of hypervisor 112 to communicate with the virtual infrastructure manager 120.

Further, the plurality of storage clusters exist in a colocation data center (e.g., where the nodes, bandwidth, etc. are rented out to individual users), and each of the plurality of storage clusters can involve a plurality of storage nodes as illustrated in FIG. 7. Through such implementations as described herein, the storage nodes 3 can facilitate a colocation data center, where the nodes 3 can be used for a plural of users based on their requests.

In an example implementation, management server 1 can involve CPU 12 to be configured to facilitate the function of resource management service function 130, such that responsive to a request to expand a first storage cluster from the plurality of storage clusters, CPU 12 is configured to execute the flow of FIG. 3 and facilitate the flow of FIG. 5, provide an instruction to a virtual infrastructure manager to add an unused storage node 2 from the plurality of storage nodes to the first storage cluster of the plurality of storage clusters and directed to the first storage cluster as shown at 301 to 302 of FIG. 3. CPU 12 can then expand storage software service of the first storage cluster of the plurality of storage clusters to the added unused storage node by installing storage service 114 and manage service 115 to the unused node 2 to be added. Once installed, the CPU 12 is configured to execute, on the first storage cluster of the plurality of storage clusters, the storage service 114 to direct the added unused storage node to the first storage cluster as illustrated at 303 and 304 of FIG. 3.

In an example implementation, management server 1 can involve CPU 12 to be configured to facilitate the function of resource management service function 130, such that responsive to another request to contract a second storage cluster from the plurality of storage clusters as illustrated in FIG. 4, the CPU 12 is configured to execute the flow of FIG. 4 and facilitate the flow of FIG. 6, on the second storage cluster, the storage service 112 to remove one or more storage nodes from the plurality of storage nodes used by the second storage cluster and migrate data from the one or more storage nodes used by the second storage cluster to other storage nodes of the plurality of storage nodes used by the second storage cluster as illustrated in FIG. 4 and the flow from 400 to 402 as well as FIG. 6 and the flow at 600 to 604; and provide another instruction to the virtual infrastructure manager to remove the one or more storage nodes used by the second storage cluster and to change the one or more storage nodes to become unused as illustrated through the flows of 403 and 404 of FIG. 4.

As illustrated in FIG. 1, each of the storage cluster can be configured to respond to a request for a read operation or a write operation from an application in the public cloud, whereupon storage service can facilitate the response (e.g., providing the data associated with the request for a read operation, writing the data associated with a write request and providing acknowledgement or status, etc.) in accordance with the desired implementation.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A management server configured to manage a plurality of storage clusters, each of the plurality of storage clusters associated with a user, each of the plurality of storage clusters configured to be isolated from each other, each of the plurality of storage clusters configured to be directed to a public cloud, the management server comprising:
a processor, configured to, responsive to a request to expand a first storage cluster from the plurality of storage clusters:
provide an instruction to a virtual infrastructure manager to add an unused storage node to the first storage cluster and directed to the first storage cluster;
expand storage software service of the first storage cluster to the added unused storage node, and
execute, on the first storage cluster, the storage software service to direct the added unused storage node to the first storage cluster.

2. The management server of claim 1, wherein the processor is configured to, responsive to another request to contract a second storage cluster from the plurality of storage clusters:
execute, on the second storage cluster, the storage software service to remove one or more storage nodes used by the second storage cluster and migrate data from the one or more storage nodes used by the second storage cluster to other storage nodes used by the second storage cluster; and
provide another instruction to the virtual infrastructure manager to remove the one or more storage nodes used by the second storage cluster and to change the one or more storage nodes to become unused.

3. The management server of claim 1, wherein the plurality of storage clusters exist in a colocation data center, and each of the plurality of storage clusters comprises a plurality of storage nodes.

4. The management server of claim 1, wherein the first storage cluster is configured to respond to a request for a read operation or a write operation from an application in the public cloud.

5. A method for a system involving a plurality of storage clusters, each of the plurality of storage clusters associated with a user, each of the plurality of storage clusters configured to be isolated from each other, each of the plurality of storage clusters configured to be directed to a public cloud, the method comprising:
responsive to a request to expand a first storage cluster from the plurality of storage clusters:
providing an instruction to a virtual infrastructure manager to add an unused storage node to the first storage cluster and directed to the first storage cluster;
expanding storage software service of the first storage cluster to the added unused storage node, and
executing, on the first storage cluster, the storage software service to direct the added unused storage node to the first storage cluster.

6. The method of claim 5, further comprising, responsive to another request to contract a second storage cluster from the plurality of storage clusters:
executing, on the second storage cluster, the storage software service to remove one or more storage nodes used by the second storage cluster and migrate data from the one or more storage nodes used by the second storage cluster to other storage nodes used by the second storage cluster; and
providing another instruction to the virtual infrastructure manager to remove the one or more storage nodes used by the second storage cluster and to change the one or more storage nodes to become unused.

7. The method of claim 5, wherein the plurality of storage clusters exist in a colocation data center, and each of the plurality of storage clusters comprises a plurality of storage nodes.

8. The method of claim 5, wherein the first storage cluster is configured to respond to a request for a read operation or a write operation from an application in the public cloud.

9. A system, comprising:
a plurality of storage nodes configured to provide storage;
a plurality of storage clusters, each of the plurality of storage clusters associated with a user, each of the plurality of storage clusters configured to be isolated from each other, each of the plurality of storage clusters configured to be directed to a public cloud, each of the plurality of storage clusters facilitated by one or more of the plurality of storage nodes; and
a management server, comprising:
a processor, configured to, responsive to a request to expand a first storage cluster from the plurality of storage clusters:
provide an instruction to a virtual infrastructure manager to add an unused storage node from the plurality of storage nodes to the first storage cluster of the plurality of storage clusters and directed to the first storage cluster;
expand storage software service of the first storage cluster of the plurality of storage clusters to the added unused storage node, and
execute, on the first storage cluster of the plurality of storage clusters, the storage software service to direct the added unused storage node to the first storage cluster.

10. The system of claim 9, wherein the processor is configured to, responsive to another request to contract a second storage cluster from the plurality of storage clusters:
execute, on the second storage cluster, the storage software service to remove one or more storage nodes from the plurality of storage nodes used by the second storage cluster and migrate data from the one or more storage nodes used by the second storage cluster to other storage nodes of the plurality of storage nodes used by the second storage cluster; and
provide another instruction to the virtual infrastructure manager to remove the one or more storage nodes used by the second storage cluster and to change the one or more storage nodes to become unused.

11. The system of claim 9, wherein the plurality of storage clusters exist in a colocation data center, and each of the plurality of storage clusters comprises multiple ones of the plurality of storage nodes.

12. The system of claim 9, wherein the first storage cluster is configured to respond to a request for a read operation or a write operation from an application in the public cloud.
